(19) United States
(12) Patent Application Publication
(10) Pub. No.: US 2016/0183089 A1
(43) Pub. Date: Jun. 23, 2016

(54) WLAN AUTHENTICATION ACCESS CONTROL

(71) Applicant: Vodafone IP Licensing Limited, Newbury (GB)

(72) Inventors: Christopher David Pudney, Newbury (GB); Assen Golaup, Newbury (GB)

(21) Appl. No.: 14/860,704

(22) Filed: Sep. 21, 2015

Related U.S. Application Data
(63) Continuation of application No. PCT/GB2014/050701, filed on Mar. 10, 2014.

(30) Foreign Application Priority Data
Mar. 19, 2013 (GB) 1305050.5

(51) Int. Cl. H04W 12/06; H04W 36/22; H04W 36/14

(52) U.S. Cl. CPC H04W 12/06; H04W 36/14; H04W 36/22; H04W 88/06

(57) ABSTRACT

Authentication control for devices within a cellular network is provided. The authentication between a device and an authenticating entity within the cellular network allows the device to access a non-cellular network via one or more access points. Information is obtained about a load caused by the devices located within a cell or cell group performing authentication. If it is determined that the load requires to be controlled, the cellular network controls performance of the authentication by a set of the devices. An indication that performance of the authentication by a device must be controlled is received and performance of the authentication by the device is controlled based on the indication. An identity of a cell or group of cells providing coverage in an area where an access point is located is included within a field of a RADIUS or DIAMETER message, forwarded by the access point to an authenticating entity.

### FIELD OF THE INVENTION

The invention concerns control of authentication of a device within a cellular network, the authentication for allowing the device to access a non-cellular network via an authenticator (e.g., an access point).

### BACKGROUND

The Wireless Local Area Network (WLAN) ecosystem (e.g. Wi-Fi Alliance) have been developing certifications (e.g. Passpoint™ based on WFA Hot Spot 2.0 specifications) that can automate the mobile device access to WLAN networks using 802.1x port based authentication and hence make the user access experience to WLAN more cellular like. In order to provide security matching that of cellular networks, authentication signalling towards the centralised Authentication, Authorisation and Accounting server (AAA server) in the service provider's core network is required, especially when using cellular network credentials like those in the (U)SIM (Universal Subscriber Identity Module).

However, uncontrolled automatic authentication by smartphones on WLAN access networks can create signalling overload on critical cellular Core network elements, especially the 3GPP AAA server and the subscription databases like Home Location register (HLR). The problem is caused by the 3GPP AAA server receiving too many requests for authentication within a certain time (relative to its dimensioned capacity) and/or the interface between the 3GPP AAA server and a subscription database (HLR) being overloaded with signalling.

This problem has been recognised by the GSM Association (GSMA) and the Wireless Broadband Alliance (WBA) and a task force has been setup to find solutions to this problem. Solutions are required for the following scenarios:
UE (User Equipment) mobility in dense hotspot scenarios e.g. stadiums
Wide scale deployment of community Wi-Fi solutions;
Transport hubs creating sudden surge of authentication when users alight at train stations or airports.

The following solution categories have been considered to reduce and control signalling load on the cellular operator 3GPP AAA server and subscription databases due to WLAN authentication.

1. Control the behaviour of UE-Reduce number of full authentication requests to core network.

One basic approach is for the operator to define Access Network Discovery and Selection Function (ANDSF) new operator policies (specified in 3GPP TS 24.312) that:
a) Provide policies about subscription validity to prevent a UE from trying to associate with a WLAN Access Point (AP) when that WLAN network would not be suitable (e.g. because the UE subscription does not allow WLAN access in the given UE location or is not valid for the time of the day).
b) Allow the operator to control, per type of AP (SSID, OUI, Venue Type, etc. . . .), the frequency of authentication requests (low, medium, high) or maximum number of authentication requests that a UE may use to try to associate with this AP.
c) Allow the operator to define policy for a UE to authenticate/not authenticate to a certain AP type depending on its mobility state. The connection manager may use proprietary solutions to estimate the UE speed and map to the mobility state defined in the operator policy (mobility state definitions in terms of UE speed could be specified). Examples of policies could be:
   for a ‘High’ mobility state UE to not associate to a certain type of AP e.g. ‘shopping mall APs’ but allowed to associate to ‘Transport based’ APs e.g. APs on trains.
   for a UE with ‘high’ mobility state to wait for a certain time period to associate on the AP (e.g. prevents UE in car associating to AP at traffic light).
d) Allow an operator to define policy based on UE knowledge of previously connected AP type and detected AP type e.g. randomly delay access to an AP of type ‘station’ over a time period (defined in the policy) if the previously connected AP type was ‘transport based’ e.g. to spread signalling load and avoid signalling peaks at train stations.
e) Allow operator to define policy that limits or prevents authentication requests from a device where the received signal strength of the target AP is below a certain threshold e.g. to prevent UE authenticating at the edge of an AP and then immediately moving out to a different AP, especially if the UE is ‘ping-ponging’ between the APs.

A drawback of this solution is that the ANDSF policies are static do not respond to dynamic changes in AAA server load.

2. Control UE behaviour when authentication requests either fail or are rejected.

Define appropriate error codes (and scope and time duration) that are interpreted by the UE to:
a. Stop retrying an access attempt to the same WLAN access during a delay set by the network (e.g. when the rejection corresponds to a temporary network overload), or
b. Stop retrying an access attempt to any AP of the same WLAN access indefinitely when the rejection is due to a permanent error (e.g. no subscription to the service on this WLAN access), and/or

A drawback of this solution is that it only limits the signalling due to re-authentication.

3. Use key caching for deployments where a WLAN controller is deployed.
a. In its most basic form it involves caching the Pairwise Master Key (PMK) in each AP so that it can be re-used if the UE returns to the same AP. However, it can also be used in a form whereby the UE can pre-authenticate in its current AP in order to prepare new PMKs for visiting neighbouring APs under the same WLAN access controller. This pre-authentication is done locally by the WLAN controller and does not increase load on the AAA.
b. There are also more sophisticated techniques where a single PMK (pairwise master key) or PTK (pairwise transient key) can be used across multiple APs. Examples of these approaches include Cisco's proprietary CCKM technique, and Proactive Key Caching (PKC) (also called Opportunistic Key Caching, OKC) which was introduced in 802.11i. These are more efficient than PMK caching but have the disadvantage that they are not as widely supported on clients.
c. 802.11r is a more efficient form of PKC/OKC which aims to deliver AP transition times on a par with the proprietary CCKM solution.

These solutions are effective for scenarios where a WLAN controller is present for the PMK caching and surrounding APs which UE can visit can be prepared for them to allow the UE access without authentication. However, these solutions are ineffective for scenarios like community Wi-Fi.

4. Fast re-authentication techniques to limit signalling traffic sent to core network nodes.

These are enabled by the Authentication Server providing Fast Re-Authentication Identity and other parameters to the Wireless Protected Access (WPA) supplicant instantiated on the end-user device, as part of normal Full Authentication procedure. When the WPA supplicant requires authentication subsequent to a given Full Authentication, it can optionally use a Fast Re-authentication procedure. The signalling load generated by the fast Re-authentication procedure is less than that required for a full authentication.

This solution does not prevent or limit the generation of unnecessary authentication attempts and is only useful if each UE has to perform frequent authentication.

5. Only authenticate when traffic needs to be passed

The basic approach is for the device operating system to define logic that gauges whether any applications are ready to consume data or are entitled to consume data.

This solution relies on an accurate estimate of the data activity of the UE.

6. Control behaviour of AAA server
a. Rate limit number of authentication requests
b. Limit number of authentication requests a AAA server can send to other AAA servers and/or towards an HLR/HSS

Such an approach does not distinguish between unnecessary authentication requests and authentication requests that are meaningful. Thus, it might end up penalising users who really need to access WLAN at the benefit of users who do not need access at the time but UE is just making automatic and unnecessary authentication.

In addition, the 3GPP cellular network already has a mechanism called ‘Access Class Barring’ (as defined in TS 25.331 for 3G and TS 36.331 for LTE) which can be used by the cellular radio access network to control both the radio access load and also core network load. The start of the Access Class Barring can be done by OAM configuration or automatically based on signalling from Core Network to the Radio Access Node.

Access Class barring relies on the principle that a UE in Cellular ‘Idle’ mode can receive paging messages for it to read the cellular network system information broadcast. The UE turns on the access class barring based on the indicated parameters.

Accordingly, there is a need for a solution that controls in an effective and simple manner the authentication of WLAN.

### SUMMARY OF THE INVENTION

According to a first aspect of the invention there is provided a method for performing control of authentication for one or more devices within a cellular network, the authentication for allowing the one or more devices to access a non-cellular network via one or more access points, the authentication being between the one or more devices and an authenticating entity within the cellular network, the method comprising: obtaining information about a load caused by the one or more devices performing authentication, the one or more devices located within a cell or a group of cells; and if it is determined that the load requires to be controlled, causing the cellular network to control performance of the authentication by a set of the one or more devices. The information may be dynamic.

The non-cellular network may be a Wireless Local Area Network (WLAN). Thus, it may be understood that an alarm may be raised at the cellular network's Core Network (CN), particularly an Operations and Maintenance (O&M) system of the cellular network, indicating that the cellular network operator's AAA server is being overloaded by authentication requests to access a non-cellular network, such as a WLAN.

The access point may be an access point of the non-cellular network. Alternatively, it could be envisaged that the access point is a cellular network access point provided with the capability of acting as the access point of a non-cellular network (e.g., by way of a non-cellular network module).

The method may further comprise determining whether the load requires to be controlled. The determining may comprise counting a number of authentication operations at an authenticating entity. In this way, an overload situation may be identified.

The authentication may be performed via an authenticator. The authenticator may be configured to control access of the device to the non-cellular network. The access point may act as the authenticator. The authenticating entity may be an authentication server.

The method may further comprise determining the set of one or more devices for which performance of the authentication must be controlled. In particular, the step of determining may comprise ascertaining an area from where a plurality of authentication requests originate causing the load. For example, this may a busy town centre or football stadium or similar.

The method may further comprise obtaining identity information of the cell or the group of cells whose load requires to be controlled (for example, covering the region where load caused by WLAN authentication requires to be controlled). The identity information may be obtained through a field contained in an authentication message sent by the one or more devices to an authentication server associated with the one or more access points. The cell or the group of cells may be of the cellular network and/or the non-cellular network (for example, the cell may be an AP)

The method may further comprise obtaining authentication load information by a device of the one or more devices, the authentication load information including one or more of: a number of authentication attempts by the device; location information associated with the authentication attempts; and time information associated with the authentication attempts. The method may further comprise recording, by the device, the authentication load information; and forwarding, by the device, the authentication load information to the cellular network. The forwarding may occur upon the device connecting to the cellular network if it was not previously connected to the network or if there is an existing cellular connection, before the connection is terminated. The device may report the authentication load information using cellular control plane signalling (3GPP RRC signalling) or send the report using any user plane connectivity it gets on the cellular network or non-cellular network to an entity in the cellular network collecting the information.

The cellular network (and preferably its O&M system, although the Core Network may do this instead) and/or non-cellular network (such as WLAN) may then be configured to control (for example, activate, deactivate or adjust) an authentication restriction to the non-cellular network for the set of the devices (especially UEs), particularly in a particular area. This may be achieved by sending signalling to control the authentication restriction over the cellular network (as the cellular network AAA server or HSS may be overloaded). This may be done by the Radio Access Network (RAN), especially a RAN entity, of the cellular network. Additionally or alternatively, the non-cellular network (such as WLAN) and more specifically an O&M system of the non-cellular network (assuming that one exists) may be configured to send signalling to control the authentication restriction, for example by restricting to those in the busy area to control the load. The WLAN RAN network, especially an AP may be used to send this signalling.

The step of causing may further comprise signalling information from the cellular network, the information comprising one or more of: an indication of the set of one or more devices for which performance of the authentication must be controlled; an indication of the cell or group of cells where authentication control must be applied; and an indication of one or more parameters associated with the authentication control. The signalling information may be sent to the cell or group of cells where authentication control must be applied for instructing the set of one or more devices accordingly and/or to the set of one or more devices directly. Additionally or alternatively, the signalling may sent to the non-cellular network for sending to the set of one or more devices.

In accordance with a further aspect of the present invention there may be provided an apparatus for performing control of authentication for one or more devices within a cellular network, the authentication for allowing the one or more devices to access a non-cellular network via one or more access points, the authentication being between the one or more devices and an authenticating entity within the cellular network, the apparatus comprising: means for obtaining information about a load caused by one or more devices performing authentication, the one or more devices located within a cell or a group of cells; and if it is determined that the load requires to be controlled, means for causing the cellular network to control performance of the authentication by a set of the one or more devices. Alternatively, the apparatus may comprise: a processing component, configured to obtain information about a load caused by one or more devices performing authentication, the one or more devices located within a cell or a group of cells. The processing component may be further configured to cause the cellular network to control performance of the authentication by a set of the one or more devices if it is determined that the load requires to be controlled. The apparatus may be a network entity or a part of a network entity of the cellular network. The apparatus may optionally have features corresponding with any of the method features described herein.

In accordance with a further aspect of the present invention there may be provided a method for performing control of authentication for one or more devices within a cellular network, the authentication for allowing the one or more devices to access a non-cellular network via one or more access points, the authentication being between the one or more devices and an authenticating entity within the cellular network, the method comprising: receiving an indication that performance of the authentication by a device of a set of the one or more devices must be controlled; and controlling, based on said indication, performance of the authentication by the device. The method may be carried out in the cellular network, the non-cellular network or a combination of the two.

Controlling performance of the authentication may comprise inhibiting the device from performing the authentication. For example, the step of inhibiting may comprise sending an instruction from the cellular network (such as from a RAN part of the cellular network, for example a base station) and/or the non-cellular network (such as from a WLAN AP) to the device to avoid transmitting a request for the authentication. The instruction may be specific to the device or the instruction may be addressed to a group of devices. The instruction may identify the device directly or it may identify the device by means of a characteristic of the device or a subscription associated with the device, such as an access class. Thus, the inhibition may be achieved by implementation of an access class barring-type approach. In some embodiments, all devices of a particular cell (base station and/or AP) may be instructed to inhibit authentication requests. The instruction may specify a length of time or it may be indefinite. It will also be appreciated that these features may optionally be applied to the method of the first aspect.

The combination of this further aspect with any other aspect of the invention or one or more features of another aspect of the invention is also provided. In some embodiments, the step of controlling may be the same as the step of causing the cellular network to control performance of the authentication by a set of the one or more devices of the first aspect, although in other embodiments there may be differences. For example, the step of causing the cellular network to control performance of the authentication by a set of the one or more devices may comprise signalling an indication which is then received in the step of receiving an indication that performance of the authentication by a device of a set of the one or more devices must be controlled. Moreover, the step of inhibiting the device may overlap with the step of signalling

In accordance with a further aspect of the present invention there may be provided an apparatus for performing control of authentication for one or more devices within a cellular network, the authentication for allowing the one or more devices to access a non-cellular network via one or more access points, the authentication being between the one or more devices and an authenticating entity within the cellular network, the apparatus comprising: means for receiving an indication that performance of the authentication by a device of a set of the one or more devices must be controlled; and means for controlling, based on said indication, performance of the authentication by the device. Alternatively, the apparatus comprises: a processing component configured to receive an indication that performance of the authentication by a device of a set of the one or more devices must be controlled. The processing component may be further configured to control, based on said indication, performance of the authentication by the device. It will be appreciated that optional features of the apparatus of this further aspect may be provided corresponding with any optional features of the method of the further aspect described herein.

In accordance with a further aspect of the present invention there may be provided a method for facilitating measurement of a load on a cell or a group of cells of a cellular network, the load being caused by one or more devices performing authentication, the one or more devices located within the cell or the group of cells, the authentication being between the one or more devices within a cellular network and an authenticating entity within the cellular network, the authentication for allowing the one or more devices to access a non-cellular network via one or more access points, the method comprising: providing information for inclusion within a field of a RADIUS or DIAMETER message, said information associated with an identity of a cell or group of cells which provide coverage in the area where one of the access points from the one or more access points is located. The RADIUS or DIAMETER message may be forwarded by the access point to the authenticating entity (e.g., an authentication server). The information may be used by the cellular network in the process of identifying for which one of the cell or group of cells an authentication control must be applied.

In accordance with a further aspect of the present invention there may be provided an apparatus for facilitating measurement of a load on a cell or a group of cells of a cellular network, the load being caused by one or more devices performing authentication, the one or more devices located within the cell or the group of cells, the authentication being between the one or more devices within a cellular network and an authenticating entity within the cellular network, the authentication for allowing the one or more devices to access a non-cellular network via one or more access points, the apparatus comprising: means for providing information for inclusion within a field of a RADIUS or DIAMETER message, said information associated with an identity of a cell or group of cells which provide coverage in the area where one of the access points from the one or more access points is located. The RADIUS or DIAMETER message may be forwarded by the access point to the authenticating entity (e.g., an authentication server). Alternatively, the apparatus may comprise: a processing component, configured to provide information for inclusion within a field of a RADIUS or DIAMETER message, said information associated with an identity of a cell or group of cells which provide coverage in the area where one of the access points from the one or more access points is located. The RADIUS or DIAMETER message may be forwarded by the access point to the authenticating entity (e.g., an authentication server). The information may be used by the cellular network in the process of identifying for which one of the cell or group of cells an authentication control must be applied.

In accordance with a further aspect of the present invention there may be provided a computer program comprising instructions which when executed by one or more processors cause an authentication control element of a device within a cellular network to perform any of the above steps. There may also be provided a computer program product comprising memory comprising the computer program. An apparatus configured to operate in accordance with any of the method aspects is also provided. The apparatus may comprise a processing component. In all of the apparatus described herein, a processing component may comprise an electronic processor (for example, a microprocessor, reconfigurable logic, digital logic, a finite state machine or similar technology), optionally with memory and typically having at least one input port and at least output port for communication.

### BRIEF DESCRIPTION OF THE DRAWINGS

An example of the present invention will now be described in detail with reference to the accompanying drawings, in which:

FIG. 1 shows some exemplary procedures for assessing non-cellular authentication load and association with cellular cell identity;

FIG. 2 shows an exemplary architecture and procedure according to an embodiment of the present invention; and

FIG. 3 shows an exemplary signalling flow for a procedure according to an embodiment of the present invention; and

FIG. 4 shows an exemplary coding of the access control information in LTE system information.

### DETAILED DESCRIPTION

The main objective of the invention is to control the mobile device/UE (e.g., a device capable of being connected with a plurality of different networks, for example a cellular network such as GSM, 3G, LTE, and a non-cellular network, such as WLAN) behaviour related to WLAN authentication by sending signalling on the cellular network (which the UE is camped on) to inhibit UE access on WLAN.

While devices are often referred to as “mobile” in the description herein, the term “mobile” should not be construed to require that a device always be mobile, merely that it has the capability of being in communication with a wireless telecommunications network which allows mobility. For instance, a PC terminal or a machine to machine client that is never moved from a particular geographic location may in a sense still be considered mobile as it could be moved to a different location yet still access the same network. Where the term “mobile device” is used in the present discussion it is to be read as including the possibility of a device that is “semi-permanent” or even “fixed” where the context does not contradict such an interpretation.

According to the current invention, the cellular network operator monitors the WLAN authentication load on the 3GPP AAA server and Subscription database interface for potential overload occurrence. The cellular network may further define counters to specifically assess the level of loading caused by WLAN authentication and the location where the authentication signalling originates e.g. cellular cell id.

The load caused by WLAN authentication is identifiable by counting the number of EAP authentications for WLAN access towards the AAA server within a monitoring period.

In order to efficiently suppress excess load due to WLAN authentication only in areas where there is a high rate of WLAN authentication requests generated, it is desirable that the entity counting the WLAN authentication load knows which one is the cell which UE is camped on at the point of the WLAN authentication request. Several approaches can be considered in order to do so. Some exemplary approaches are described below.

According to one approach, the Extensible Authentication Protocol (EAP) peer responsible for initiating the authentication process in the UE acquires the Global cell Identity of the cell which UE is currently camped on or last camped on and includes this information in the EAP payload sent to the authentication server. The entity monitoring the WLAN Authentication load will then be able to map the origin of the authentication request to specific cellular cells. Inclusion of cell id in EAP payload requires extension of the EAP protocol.

According to a second approach, the WLAN AP/AP controller may be able to obtain information about the Cell Identity of the cellular cell providing coverage to the WLAN AP (e.g. preconfigured in WLAN AP deployed by the cellular operator) and includes the information in the RADIUS/DIAMETER message which forwards the EAP payload to the AAA server. In this case, the global Cell identity resides within an extension of the RADIUS or DIAMETER message. The EAP payload is provided by the UE and is then encapsulated by the WLAN AP into the RADIUS/DIAMETER message.

According to a third approach, in absence of cell information related to the WLAN authentication, the entity may still be able to identify the group of cells causing excessive WLAN authentication load by using the UE identity (IMSI) contained in the EAP payload to identify the Tracking area(s) where UE is located as such information is already stored in the cellular core network and used for other purposes like paging.

In addition, according to a fourth approach, the problem of identifying the WLAN authentication load on a per cellular cell basis can be achieved by having a monitoring entity in the WLAN AP/AP controller which has a cellular downlink receiver to read the system information of the strongest cellular cell and hence identify automatically the global cell id of the cell providing coverage to the WLAN AP being monitored.

Additionally or alternatively, the cellular network may request devices to store information about non-cellular authentication attempts together with time stamp and location information. Devices send the stored information to the cellular network the next time they connect to the cellular network, before termination of an ongoing cellular connection using control plane signalling (RRC signalling). Alternatively, the stored information may be reported using user plane connectivity on the cellular network or WLAN network to an entity in the cellular network collecting the UE reports.

Using one of the approaches outlined above, the cellular network will be able to identify the WLAN authentication load generated on a per cell basis or per group of cells basis.

If network counters indicate that WLAN authentication load on the AAA server and HLR interface exceed a preconfigured/predetermined level, alarms may be generated and/or signalling sent to the cellular radio access network to start broadcast signalling that will inhibit all or a fraction of UEs in the network from doing authentication attempts on WLAN and if, additionally, counters are available on a per cellular cell basis, the access control signalling may be started on specific cellular cells which is more effective at suppressing WLAN authentication load without penalising UEs in areas where WLAN authentication signalling is not excessive.

Additionally, the cellular network may process logs of WLAN authentication attempts sent by devices to evaluate the areas e.g. cells or group of cells in the network and the time of the day where significant WLAN authentication requests occur and take proactive measures to start WLAN authentication control in the problematic areas.

The signalling to limit authentication attempts can be based on one or more of the following principles:
1) Authentication to WLAN can be restricted to a fraction of UEs in the network based on their access classes or an IMSI group e.g. groups of UEs with same paging occasions.
2) Authentication to WLAN can be restricted to specific cellular cells or groups of cellular cells where the counters indicate a high load from WLAN authentication e.g. cells covering shopping centre, a train station or stadium.
3) Authentication to WLAN can be restricted for a certain time period. In order to avoid subsequent peaks in WLAN authentication signalling when the restriction is removed, the network may either indicate different durations for different access classes or the data connection manager can randomise the duration for which WLAN authentication is prevented according to broadcast/multicast parameters.
4) When access control for WLAN authentication is required, the radio access network is triggered by OAM or signalling from the CN to the cellular Radio Access Nodes to start broadcasting/multicasting the WLAN access control information. UEs may be paged (according to 3GPP procedures) with configuration information that will determine which UEs are inhibited or paged to read the new system information in the affected cellular cells or group(s) of cells to provide configuration information that will determine which UEs are inhibited (e.g. restriction can be on UEs with specific access classes) from WLAN access and the time period for which the inhibition applies. Alternatively, the WLAN access restriction information may be contained within paging messages sent to groups of UEs in their paging occasions.
5) The 3GPP modem in UEs which receive the WLAN access control information will pass it to the apparatus performing WLAN authentication control for both the case where the indication is ‘not allowed’ and the case where the indication is ‘allowed’.
6) The apparatus performing WLAN authentication control uses the information to inhibit authentication to the WLAN network for the specified duration or remove inhibition if indicated by the network.

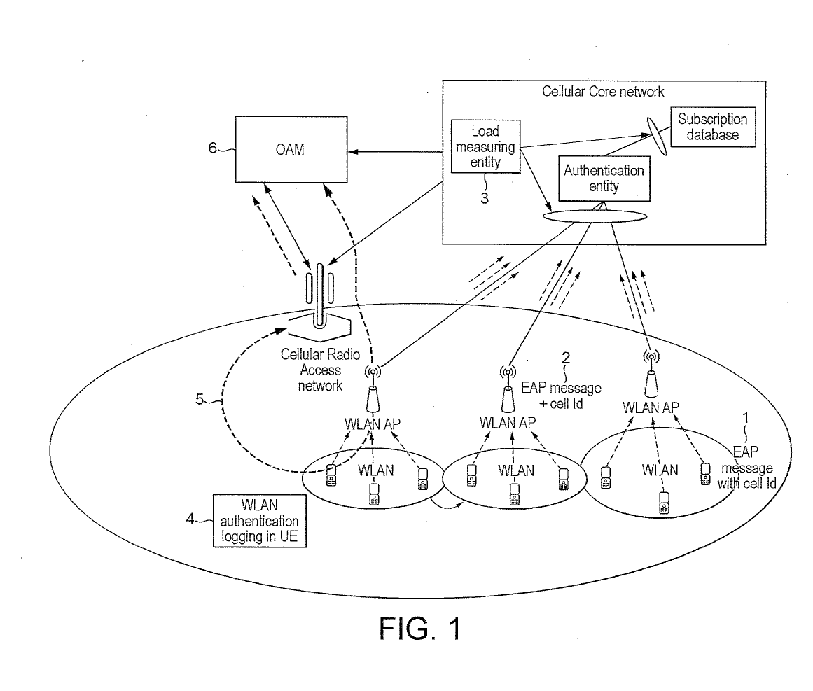

FIG. 1 is now described. In step 1, device includes a unique identity of the cellular cell where it currently is in the authentication message which is sent to the authentication entity. In step 2, the non-cellular access point may deduce the unique identity of the cellular cell which overlays the WLAN AP (e.g. by configuration or with a cellular downlink receiver) and include the cell identity in the message used to convey the authentication payload to the authentication entity. In step 3, a non-cellular load measuring entity deduces the authentication load on the authentication entity and/or subscription database interface and may additionally deduce the load on a per cellular cell basis using information including in the authentication message as per step 1 and/or step 2. In step 4, device stores a log of the non-cellular authentication attempts it makes with location and time information. In step 5, device reports the stored log to the cellular network the next time it connects to the cellular network e.g. to make or receive a call or before termination of an ongoing call using control plane signalling (RRC signalling). Alternatively, the stored log may be sent using any user plane connectivity on the cellular or non-cellular network. In step 6, a cellular network entity may process the logs from devices and deduce the need for Non-cellular authentication restriction on a per cellular cell basis and/or at different times of the day.

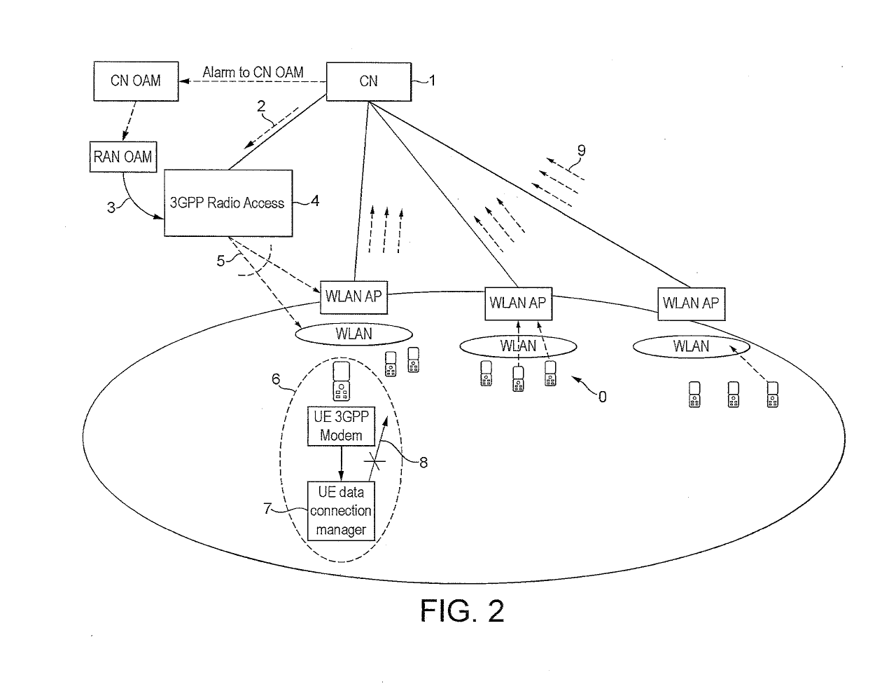

FIG. 2 is now described. In step 20, Dual mode UEs are performing uncontrolled WLAN authentication requests. In step 21, CN detects increased load from WLAN authentication requests. In step 22, CN sends signalling to cellular radio access network node to start WLAN access control. In step 23, optionally, WLAN access control in radio access node may be triggered by O&M based on alarms on AAA server/HLR interface loading or logs received from UE on WLAN authentication load. This may be done by WLAN O&M staff. Some Wi-Fi controllers may be available where (new) signalling can be sent to UEs to suppress authentication, such as when they try to access other Wi-Fi networks. In step 24, Radio access node starts WLAN access control based on O&M configuration or signalling from core network. In step 25, WLAN access control information is broadcast in system information or indicated by paging mechanisms to the UE. In step 26, the UE acquires WLAN access control information in system information or paging message. In step 27, the UE forwards WLAN access control parameters to apparatus controlling WLAN authentication. In step 28, apparatus controlling WLAN authentication inhibits or allows connection to WLAN depending on WLAN access control information setting. In step 29, Authentication requests (red arrows) not generated as UEs are inhibited from making WLAN automatic access.

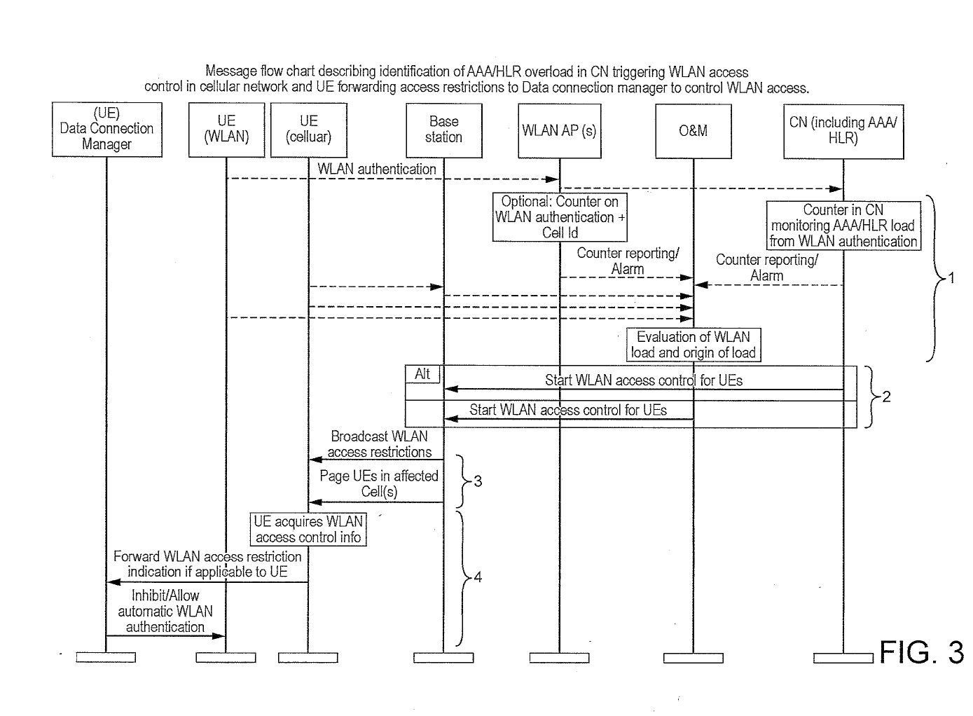

FIG. 3 shows an exemplary signalling flow for a procedure according to an embodiment of the present invention.

In step 31, there are CN and O&M procedures to identify AAA/HLR loading from WLAN access and triggering options for WLAN access control by cellular core network or O&M. In step 32, there are procedures between CN/O&M and Radio Access Network Node to start WLAN authentication control. This assumes that CN entities (e.g., MME and SGSN) get information about AAA loading which triggers them to send the signalling to base stations. In step 33, there are Radio access network procedures to start WLAN access control. In step 34, there are UE procedures to implement WLAN access control actions.

The access control information broadcast in system information may, for example, take the form of a 10 bit bitmap which indicates which access classes (0-9) are barred from WLAN automatic access. The signalling may also contain an ‘inhibit duration’ which indicates the time for which the restriction applies. The signalling may also indicate a mean time duration over which the UE must randomise the removal of the WLAN access restriction when the restriction is removed e.g. the bitmap indicates ‘allowed’ when the previous indication was ‘not allowed’.

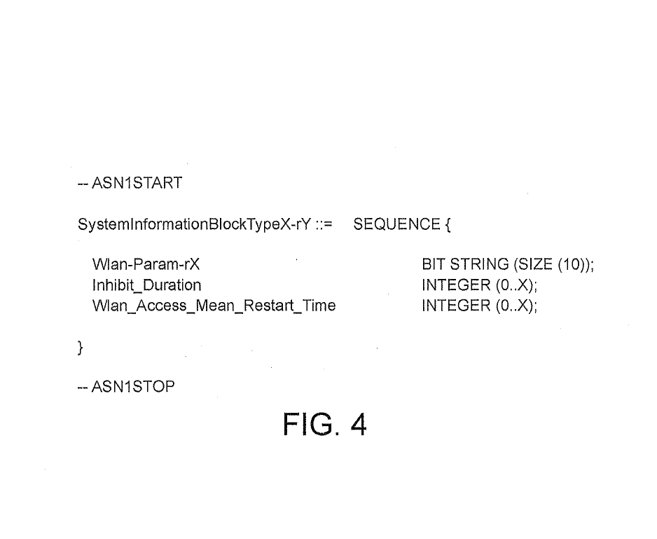

FIG. 4 shows an exemplary coding (e.g., SystemInformationBlockTypeX information element) of the access control information in LTE system information which could be specified for 3GPP TS 36.331. The IE SystemInformationBlockTypeX contains the WLAN Access control parameters. In FIG. 4, the 10 bit bitmap indicates for which access classes the WLAN authentication needs to be applied. An operator might decide to block UEs of all access classes or UEs of a subset of the access classes, depending on the severity of the WLAN authentication load.

The ‘Inhibit duration’ indicates the time for which the current configuration e.g. restriction of WLAN access applies unless overwritten by new configuration information before expiry of the inhibit duration.

The ‘WLAN access mean restart time’ indicates to the apparatus performing WLAN authentication control that it has to randomly distribute the initiation of subsequent WLAN authentication following removal of the access restriction by the network.

Alternatively, authentication control information can be sent in paging messages to UEs in cell or group of cells where WLAN authentication load need to be restricted.

Similar system information definitions can be made for other 3GPP access technologies. If the WLAN access control information is contained with a paging message, the information may be a subset of the information contained in system information.

A UE that receives the WLAN access control information passes an WLAN authentication ‘inhibit’ or ‘allowed’ flag to the upper layers and can be used by the apparatus performing the WLAN authentication control to prevent automatic WLAN access or allow automatic WLAN access if the flag indicates ‘allowed’ when it was previously ‘not allowed’.

Thus, there is provided a mechanism for a home cellular operator network to be able control WLAN authentication or association attempts for UEs that can operated with both cellular network and WLANs (especially with SIM based authentication) by communicating information to the UEs (over the cellular network or WLAN, for example). The information is typically related to restriction of the authentication or association attempts to one or more WLAN APs or other networks controlled by the operator/roaming partners of the operator (for example, a realm). This may, for example, be used to prevent UE authentication attempts over WLAN for specific areas in the network during overload situations.

The UE behaviour in response to an indication denying authentication and/or association to an AP may be fixed, in accordance with the above. Additionally or alternatively, the UE may expose any information provided by the cellular network for WLAN authentication control to the data connection manager for example via operating system APIs. The UE Data Connection manager may be able to suppress WLAN access or authentication from UEs which have received WLAN authentication control information from the cellular network.

Although a specific embodiment has been described above, the skilled person will appreciate that various alternatives or modifications may be possible. For example, the signalling to control a UE's further authentication requests need not be sent via the cellular network base station. Additionally or alternatively, it may be sent through the non-cellular network, such as the WLAN and specifically using the WLAN AP. This may be applicable if the UE is intending to switch from a WLAN of one operator to a WLAN of another operator.

However, it is thought that sending the signalling to control the authentication restriction over WLAN may not be as effective as over the cellular network. Sending signalling over the WLAN may assume that UE is already authenticated on the WLAN to receive this signalling. In contrast, sending the signalling over the cellular network may mean that UE has the information before connecting to the WLAN, which may be more effective. Also, the better coverage (in terms of geographical scope and/or reliability) of cellular networks than WLAN may provide further advantages to sending the signalling over the cellular network. Moreover, the wider coverage area of a cellular network cell than a WLAN AP may mean that by controlling a restriction on a cellular cell, a whole busy area can be blocked readily, whereas doing this using a WLAN may be a painstaking task.

A further description of the present invention is also described in the following paragraphs, which are an extract from GSMA and WBA Wi-Fi Roaming Task Force draft whitepaper on signalling optimisation.
Using Cellular Network Signalling to control WLAN authentication

Dual mode UEs can receive paging messages from the cellular network for a ‘mobile terminating call’ or for reading updated system information. It can be envisaged that the cellular network operator will be constantly monitoring the AAA server/HLR interface loading and will be able to identify the load due to WLAN authentication and perhaps more specifically, the areas where the load originate e.g. cellular cells providing overlapping coverage in areas with dense WLAN deployments and UE mobility resulting in high WLAN authentication load.

Within the 3GPP system, mechanisms have been defined (Access class barring) to allow the cellular operator to protect both the radio network and the core network nodes from signalling overload typically caused by scenarios analogous to some of the scenarios identified for WLAN authentication overload e.g. stadium situations.

One solution to control the WLAN authentication load problem is to define mechanisms similar to 3GPP signalling overload control e.g. signalling from the cellular network to restrict WLAN authentication requests which an operator can use to suppress WLAN authentication load throughout the whole network or more specifically for certain areas in the network e.g. specific cells with a large number of highly mobile UEs and dense WLAN deployment. 3GPP should specify a mechanism for the cellular network to send information to the 3GPP modem of UEs (e.g. broadcast in system information or paging message) in problematic areas which the 3GPP modem can forward to upper layers (e.g. data connection manager) to inhibit WLAN authentication for a certain configurable time period.

As a final remark, all the technical specifications, standards and/or protocols cited throughout this whole specification either by way of explicit mentioning (e.g., 3GPP TS xx.xxx, 802.1x, etc.) or by implicit mentioning (e.g., “as explained by 3GPP specifications”) are hereby incorporated by reference in their entirety.

1. A method for performing control of authentication for one or more devices within a cellular network, the authentication for allowing the one or more devices to access a non-cellular network via one or more access points, the authentication being between the one or more devices and an authenticating entity within the cellular network, the method comprising:
obtaining information about a load caused by the one or more devices performing authentication, the one or more devices located within a cell or a group of cells; and
if it is determined that the load requires to be controlled, causing the cellular network to control performance of the authentication by a set of the one or more devices.

2. The method of claim 1, wherein the control performance of the authentication includes inhibiting the set of the one or more devices from performing authentication.

3. The method of claim 1, wherein one or both of: the non-cellular network is a Wireless Local Area Network (WLAN); and the one or more access points are access points of the non-cellular network.

4. The method of claim 1, further comprising:
determining the set of one or more devices for which performance of the authentication must be controlled.

5. The method of claim 1, further comprising:
obtaining identity information of the cell or the group of cells whose load requires to be controlled.

6. The method of claim 1, further comprising:
obtaining authentication load information by a device of the one or more devices, the authentication information including one or more of:
a number of authentication attempts by the device;
location information associated with the authentication attempts; and
time information associated with the authentication attempts.

7. The method of claim 6, further comprising:
recording, by the device, the authentication load information; and
forwarding, by the device, the authentication load information to the cellular network.

8. The method of claim 1, wherein the step of causing further comprises signalling information from the cellular network, the information comprising one or more of:
an indication of the set of one or more devices for which performance of the authentication must be controlled;
an indication of the cell or group of cells where authentication control must be applied; and
an indication of one or more parameters associated with the authentication control.

9. A method for performing control of authentication for one or more devices within a cellular network, the authentication for allowing the one or more devices to access a non-cellular network via one or more access points, the authentication being between the one or more devices and an authenticating entity within the cellular network, the method comprising:
receiving an indication that performance of the authentication by a device of a set of the one or more devices must be controlled; and
controlling, based on said indication, performance of the authentication by the device.

10. The method of claim 9, wherein controlling performance of the authentication comprises inhibiting the device from performing the authentication.

11. (canceled)

12. (canceled)

13. (canceled)

14. An apparatus for facilitating measurement of a load on a cell or a group of cells of a cellular network, the load being caused by one or more devices performing authentication, the one or more devices located within the cell or the group of cells, the authentication being between the one or more devices within a cellular network and an authenticating entity within the cellular network, the authentication for allowing the one or more devices to access a non-cellular network via one or more access points, the apparatus comprising:
a processing component, configured to provide information for inclusion within a field of a RADIUS or DIAMETER message, said information associated with an identity of a cell or group of cells which provide coverage in the area where one of the access points from the one or more access points is located,
wherein the RADIUS or DIAMETER message is forwarded by the access point to the authenticating entity.

15. A non-transitory computer readable storage medium having stored thereon instructions that, when executed, cause a processor of a device to to perform the method steps claim 1.
